(19) United States
(12) Patent Application Publication
(10) Pub. No.: US 2021/0135382 A1
(43) Pub. Date: May 6, 2021

(54) Temperature Rise Warning Insulating Terminal

(71) Applicant: Jeesoon Terminals Co., Ltd., Sioushuei Township (TW)

(72) Inventor: Rong-Lie Chen, Sioushuei Township (TW)

(21) Appl. No.: 16/672,599

(22) Filed: Nov. 4, 2019

(51) Int. Cl. H01R 4/70

(52) U.S. Cl. CPC H01R 4/70

(57) ABSTRACT

An insulating terminal includes a terminal head, and an insulating sleeve mounted on the terminal head. The terminal head has a first end provided with a mounting section mounted in the insulating sleeve and a second end provided with an insertion section. The insulating sleeve includes a polyolefin and a thermochromic pigment. The polyolefin and the thermochromic pigment are regulated and pressed at a predetermined proportion to mold and form the insulating sleeve. A hot melt adhesive is coated on an inner surface of the insulating sleeve, and is mounted on the mounting section of the terminal head. Thus, when an electric current passes through the insulating sleeve, and a temperature of the thermochromic pigment rises and reaches a determined value, the thermochromic pigment of the insulating sleeve changes colors, to provide a warning effect.

### BACKGROUND OF THE INVENTION

### 1. Field of the Invention

The present invention relates to an insulating terminal and, more particularly, to a temperature rise warning insulating terminal.

### 2. Description of the Related Art

A conventional insulating terminal comprises a terminal head, and an insulating sleeve mounted on the terminal head. The insulating terminal is used for transmission of an electric current load. However, when the insulating terminal is under an overload condition during a long period of time, the temperature rises to a high value, thereby easily burning the circuit or causing a short circuit.

### BRIEF SUMMARY OF THE INVENTION

The primary objective of the present invention is to provide an insulating terminal with a warning function during temperature rise.

In accordance with the present invention, there is provided an insulating terminal comprising a terminal head, and an insulating sleeve mounted on the terminal head. The terminal head has a first end provided with a mounting section mounted in the insulating sleeve and a second end provided with an insertion section. The insulating sleeve is color changeable. The insulating sleeve has an interior provided with a through hole. The insulating sleeve includes a polyolefin and a thermochromic pigment. The polyolefin and the thermochromic pigment are regulated and pressed at a predetermined proportion to mold and form the insulating sleeve with the through hole. A hot melt adhesive is coated on an inner surface of the insulating sleeve, and is mounted on the mounting section of the terminal head. Thus, when an electric current passes through the insulating sleeve, and a temperature of the thermochromic pigment rises and reaches a determined value, the thermochromic pigment of the insulating sleeve changes colors, to provide a warning effect.

According to the primary advantage of the present invention, the insulating terminal changes colors when the temperature rises and reaches a predetermined value under an overload condition, so as to provide a warning effect to the operator, thereby assuring safety of operation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of an insulating terminal in accordance with the preferred embodiment of the present invention.

FIG. 2 is a perspective assembly view of the insulating terminal in accordance with the preferred embodiment of the present invention.

FIG. 3 is a side view of an insulating sleeve of the insulating terminal in accordance with the preferred embodiment of the present invention.

FIG. 4 is a cross-sectional assembly view of the insulating terminal showing an electric current load and a temperature rise warning condition.

FIG. 5 is a side cross-sectional view of the insulating terminal showing the electric current load and the temperature rise warning condition.

FIG. 6 is a perspective view of an insulating terminal in accordance with another preferred embodiment of the present invention.

FIG. 7 is a perspective view of an insulating terminal in accordance with a further preferred embodiment of the present invention.

FIG. 8 is a perspective view of an insulating terminal in accordance with a further preferred embodiment of the present invention.

### DETAILED DESCRIPTION OF THE INVENTION

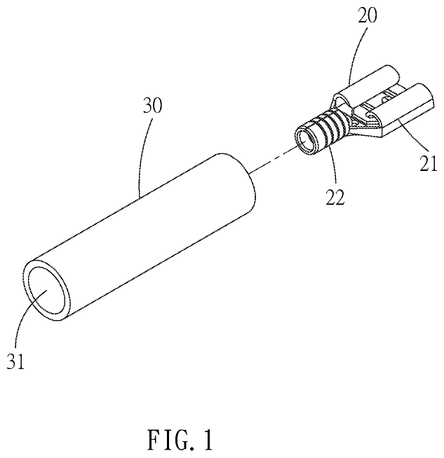

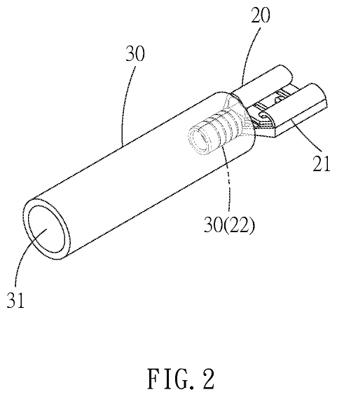

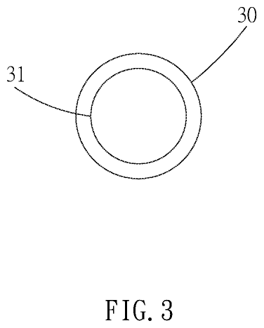

Referring to the drawings and initially to FIGS. 1-5, an insulating terminal in accordance with the preferred embodiment of the present invention comprises a terminal head 20, and an insulating sleeve 30 mounted on the terminal head 20.

The terminal head 20 has a first end provided with a mounting section 22 mounted in the insulating sleeve 30 and a second end provided with an insertion section 21.

The insulating sleeve 30 is color changeable (or color variable) and has variable colors. The insulating sleeve 30 has an interior provided with a through hole 31. The insulating sleeve 30 includes a polyolefin and a thermochromic pigment. The polyolefin and the thermochromic pigment are in the form of powder or particles. The polyolefin and the thermochromic pigment are regulated and pressed at a predetermined proportion to mold and form the insulating sleeve 30 with the through hole 31. A hot melt adhesive 32 is coated on an inner surface of the insulating sleeve 30, and is mounted on the mounting section 22 of the terminal head 20.

Thus, when an electric current passes through the insulating sleeve 30, and a temperature of the thermochromic pigment rises and reaches a determined value, the thermochromic pigment of the insulating sleeve 30 changes colors, to provide a warning effect.

In the preferred embodiment of the present invention, the determined value of the temperature of the thermochromic pigment is ranged between 40° C. and 100° C., with an interval of 10° C.

In the preferred embodiment of the present invention, the thermochromic pigment of the insulating sleeve 30 is made of temperature sensitive colored powder.

In the preferred embodiment of the present invention, the insulating sleeve 30 has diverse models. Thus, the insulating sleeve 30 is connected with various terminals and power supply connectors.

In the preferred embodiment of the present invention, the temperature of the thermochromic pigment has a discolor reaction temperature value that is preset according to a requirement.

In the preferred embodiment of the present invention, the thermochromic pigment of the insulating sleeve 30 has a proportion that is regulated to adjust depth of colors. Thus, when the proportion of the thermochromic pigment is increased, the color is darker, and when the proportion of the thermochromic pigment is decreased, the color is lighter, to satisfy the user's requirement.

In the preferred embodiment of the present invention, the polyolefin of the insulating sleeve 30 is made of HDPE, EVA or the like.

In the preferred embodiment of the present invention, the polyolefin and the thermochromic pigment are located at an outer layer of the insulating sleeve 30.

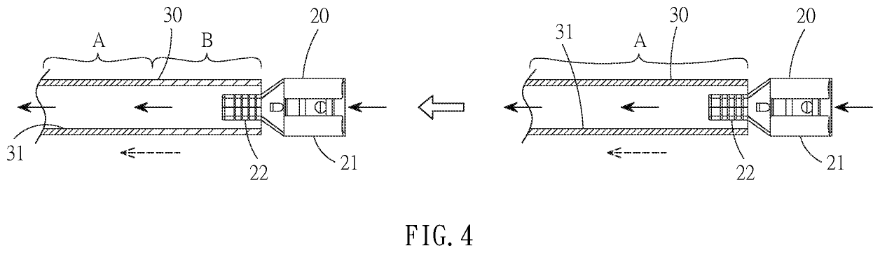

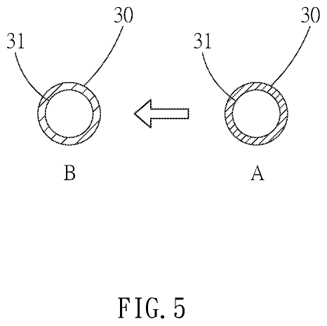

In operation, referring to FIGS. 4 and 5 with reference to FIGS. 1-3, the electric current passes through the terminal head 20 into the insulating sleeve 30. When the load of the electric current is under the normal condition, the insulating sleeve 30 is kept at a first color A which indicates an original color section. When the load of the electric current is under the abnormal condition (or overload), the temperature of the thermochromic pigment rises and reaches the preset value, such that the thermochromic pigment of the insulating sleeve 30 changes colors, and the insulating sleeve 30 is kept at a second color B which indicates a temperature rise discolor reaction section, so as to provide a warning effect. The second color B is initially located at the front end of the insulating sleeve 30, and gradually extends toward the rear end of the insulating sleeve 30. When the load of the electric current is too large or the temperature is too high, the second color B extends through the whole length of the insulating sleeve 30, which indicates the insulating terminal is in the danger of a short circuit or burning. Thus, the operator is reminded of the overload condition by distinguishing the color change of the insulating sleeve 30, so as to operate the insulating terminal safely by reducing the load or replacing a larger cable, thereby preventing the insulating terminal from being worn out. When the insulating terminal is connected with a sensitive electric controller or an electronic instrument, the insulating terminal has a color change function to provide a warning effect, to prevent the expensive appliances from being damaged due to an excessively high temperature.

Accordingly, the insulating terminal changes colors when the temperature rises and reaches a predetermined value under an overload condition, so as to provide a warning effect to the operator, thereby assuring safety of operation.

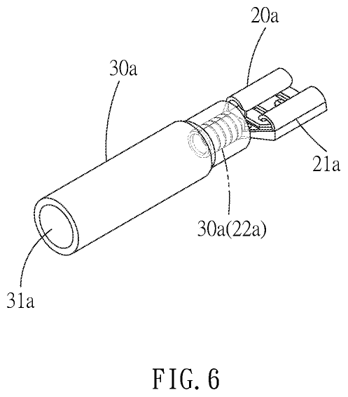

Referring to FIG. 6, the terminal head 20a has a first end provided with a mounting section 22a mounted in the insulating sleeve 30a and a second end provided with an insertion section 21a, and the insulating sleeve 30a has an interior provided with a through hole 31a. The insulating sleeve 30a has a stepped shape, with a smaller first end and a larger second end. The smaller first end of the insulating sleeve 30a is mounted on the mounting section 22a of the terminal head 20a.

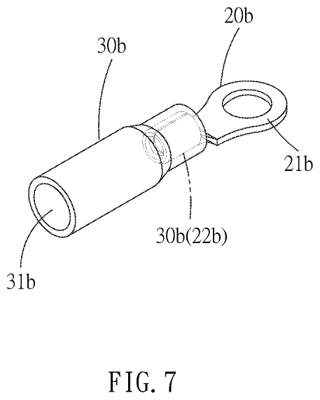

Referring to FIG. 7, the terminal head 20b has an R type and has a first end provided with a mounting section 22b mounted in the insulating sleeve 30b and a second end provided with an insertion section 21b, and the insulating sleeve 30b has an interior provided with a through hole 31b. The insulating sleeve 30b has a stepped shape, with a smaller first end and a larger second end.

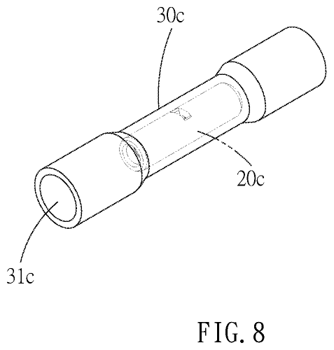

Referring to FIG. 8, the insulating sleeve 30c has an interior provided with a through hole 31c. The insulating sleeve 30c has two larger ends and a smaller middle section. The terminal head 20c is mounted in the smaller middle section of the insulating sleeve 30c.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An insulating terminal comprising:
a terminal head; and
an insulating sleeve mounted on the terminal head;
wherein:
the terminal head has a first end provided with a mounting section mounted in the insulating sleeve and a second end provided with an insertion section;
the insulating sleeve is color changeable;
the insulating sleeve has an interior provided with a through hole;
the insulating sleeve includes a polyolefin and a thermochromic pigment;
the polyolefin and the thermochromic pigment are regulated and pressed at a predetermined proportion to mold and form the insulating sleeve with the through hole;
a hot melt adhesive is coated on an inner surface of the insulating sleeve, and is mounted on the mounting section of the terminal head; and
when an electric current passes through the insulating sleeve, and a temperature of the thermochromic pigment rises and reaches a determined value, the thermochromic pigment of the insulating sleeve changes colors, to provide a warning effect.

2. The insulating terminal of claim 1, wherein the determined value of the temperature of the thermochromic pigment is ranged between 40° C. and 100° C., with an interval of 10° C.

3. The insulating terminal of claim 1, wherein the thermochromic pigment of the insulating sleeve is made of temperature sensitive colored powder.

4. The insulating terminal of claim 1, wherein the insulating sleeve has diverse models.

5. The insulating terminal of claim 1, wherein the temperature of the thermochromic pigment has a discolor reaction temperature value that is preset according to a requirement.

6. The insulating terminal of claim 1, wherein the thermochromic pigment of the insulating sleeve has a proportion that is regulated to adjust depth of colors.
